(19) United States
(12) Patent Application Publication
(10) Pub. No.: US 2024/0420192 A1
(43) Pub. Date: Dec. 19, 2024

(54) DATA MARKETPLACE PRICE CORRECTION

(71) Applicant: Dell Products L.P., Round Rock, TX (US)

(72) Inventors: Dhilip Kumar, Bangalore (IN); Shibi Panikkar, Bangalore (IN); Vibha Pandey, Bangalore (IN)

(73) Assignee: Dell Products L.P., Round Rock, TX (US)

(21) Appl. No.: 18/336,126

(22) Filed: Jun. 16, 2023

(51) Int. Cl. G06Q 30/0283

(52) U.S. Cl. CPC G06Q 30/0283

(57) ABSTRACT

An example methodology includes analyzing a data set onboarded to a data marketplace service for quality, deriving a static price depreciation coefficient based on the quality of the data set, and applying the static price depreciation coefficient to a price of the data set to determine a first new price of the data set, wherein the price of the data set is specified by a data provider that provided the data set to the data marketplace service. The method may also include analyzing error reports and feedbacks about the data set to determine a density of errors in the data in the data set, deriving a dynamic price depreciation coefficient based on the density of errors in the data in the data set, and applying the dynamic price depreciation coefficient to the price of the data set to determine a second new price of the data set.

### BACKGROUND

A data marketplace (also known as a data exchange) is an online transactional store or platform where data providers can offer their data and data consumers can purchase or subscribe to the offered data. A data marketplace provides a ready platform for data providers to market, manage, and sell their data. In turn, the data marketplace allows data consumers (or “buyers”) to browse, compare, and purchase data from different sources collected in one location.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

In accordance with one illustrative embodiment provided to illustrate the broader concepts, systems, and techniques described herein, a method includes, by a computing device, determining an onboarding of a data set to a data marketplace service by a data provider, analyzing data in the data set for quality, and deriving a static price depreciation coefficient based on the quality of the data in the data set. The method also includes, by the computing device, applying the static price depreciation coefficient to a price of the data set to determine a first new price of the data set, wherein the price of the data set is specified by the data provider, and sending a first notification of the first new price of the data set to the data provider.

In some embodiments, the quality of the data is based on a number of duplicate rows in the data set.

In some embodiments, the quality of the data is based on a number of rows with blank data in the data set.

In some embodiments, the quality of the data is based on a number of anomalies in the data set.

In some embodiments, the quality of the data is based on a number of dependent fields in the data set.

In some embodiments, the method further includes, by the computing device, analyzing error reports and feedbacks about the data set to determine a density of errors in the data in the data set, deriving a dynamic price depreciation coefficient based on the density of errors in the data in the data set, applying the dynamic price depreciation coefficient to the price of the data set to determine a second new price of the data set, and sending a second notification of the second new price of the data set to the data provider.

In some embodiments, the density of errors is based on a ratio of a number of faulty data and a number of rows having the faulty data in the data set.

In some embodiments, the density of errors is based on a ratio of a number of negative feedbacks about the data set and a number of downloads of the data set.

In some embodiments, the density of errors is based on a ratio of a number of positive feedbacks about the data set and a number of downloads of the data set.

In some embodiments, the density of errors is based on a cluster coefficient indicative of the clustering of negative feedbacks about the data set across different types of errors and issues reported about the data set.

According to another illustrative embodiment provided to illustrate the broader concepts described herein, a computing device includes one or more non-transitory machine-readable mediums configured to store instructions and one or more processors configured to execute the instructions stored on the one or more non-transitory machine-readable mediums. Execution of the instructions causes the one or more processors to carry out a process including determining an onboarding of a data set to a data marketplace service by a data provider, analyzing data in the data set for quality, and deriving a static price depreciation coefficient based on the quality of the data in the data set. The process also includes applying the static price depreciation coefficient to a price of the data set to determine a first new price of the data set, wherein the price of the data set is specified by the data provider, and sending a first notification of the first new price of the data set to the data provider.

According to another illustrative embodiment provided to illustrate the broader concepts described herein, a non-transitory machine-readable medium encodes instructions that when executed by one or more processors cause a process to be carried out, the process including determining an onboarding of a data set to a data marketplace service by a data provider, analyzing data in the data set for quality, and deriving a static price depreciation coefficient based on the quality of the data in the data set. The process also includes applying the static price depreciation coefficient to a price of the data set to determine a first new price of the data set, wherein the price of the data set is specified by the data provider, and sending a first notification of the first new price of the data set to the data provider.

In some embodiments, the process further includes analyzing error reports and feedbacks about the data set to determine a density of errors in the data in the data set, deriving a dynamic price depreciation coefficient based on the density of errors in the data in the data set, applying the dynamic price depreciation coefficient to the price of the data set to determine a second new price of the data set, and sending a second notification of the second new price of the data set to the data provider.

In accordance with one another illustrative embodiment provided to illustrate the broader concepts, systems, and techniques described herein, a method includes, by a computing device, analyzing error reports and feedbacks about a data set to determine a density of errors in data in the data set, wherein the error reports and the feedbacks provided by data consumers using the data in the data set, and deriving a dynamic price depreciation coefficient based on the density of errors in the data in the data set. The method also includes, by the computing device, applying the dynamic price depreciation coefficient to a price of the data set to determine a new price of the data set, wherein the price of the data set is specified by a data provider that provided the data set, and sending a notification of the new price of the data set to the data provider.

According to still another illustrative embodiment provided to illustrate the broader concepts described herein, a computing device includes one or more non-transitory machine-readable mediums configured to store instructions and one or more processors configured to execute the instructions stored on the one or more non-transitory machine-readable mediums. Execution of the instructions causes the one or more processors to carry out a process including analyzing error reports and feedbacks about a data set to determine a density of errors in data in the data set, wherein the error reports and the feedbacks provided by data consumers using the data in the data set, and deriving a dynamic price depreciation coefficient based on the density of errors in the data in the data set. The process also includes applying the dynamic price depreciation coefficient to a price of the data set to determine a new price of the data set, wherein the price of the data set is specified by a data provider that provided the data set, and sending a notification of the new price of the data set to the data provider.

According to a further illustrative embodiment provided to illustrate the broader concepts described herein, a non-transitory machine-readable medium encodes instructions that when executed by one or more processors cause a process to be carried out, the process including analyzing error reports and feedbacks about a data set to determine a density of errors in data in the data set, wherein the error reports and the feedbacks provided by data consumers using the data in the data set, and deriving a dynamic price depreciation coefficient based on the density of errors in the data in the data set. The process also includes applying the dynamic price depreciation coefficient to a price of the data set to determine a new price of the data set, wherein the price of the data set is specified by a data provider that provided the data set, and sending a notification of the new price of the data set to the data provider.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims appended hereto.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a diagram illustrating an example network environment of computing devices in which various aspects of the disclosure may be implemented, in accordance with an embodiment of the present disclosure.

FIG. 2 is a block diagram illustrating selective components of an example computing device in which various aspects of the disclosure may be implemented, in accordance with an embodiment of the present disclosure.

FIG. 3 is a diagram of a cloud computing environment in which various aspects of the concepts described herein may be implemented.

FIG. 4 is a diagram of an illustrative network environment in which data marketplace price correction may be implemented, in accordance with an embodiment of the present disclosure.

FIG. 5 is a block diagram of an illustrative system for data marketplace price correction, in accordance with an embodiment of the present disclosure.

FIG. 6 is a flow diagram of an example process for applying a static price correction to a price of the data set, in accordance with an embodiment of the present disclosure.

FIG. 7 is a flow diagram of an example process for applying a dynamic price correction to a price of the data set, in accordance with an embodiment of the present disclosure.

### DETAILED DESCRIPTION

A data marketplace works in the same way as any other online market which facilitates the exchange of commodities. Like these other online markets, a data marketplace is a two-sided market. The data marketplace does not own the data that is being purchased but works to the benefit of the parties selling and buying the data. There are the data providers, who are looking to commercialize their data assets, and there are the data consumers, who want to find data sources which meet their requirements. Once a data consumer finds the data which meets their requirements, the data consumer can purchase the data by paying a fixed price or under a fixed or usage-based subscription. In any case, the price paid by the data consumer is typically set by the data provider. Unfortunately, in many cases, the current mechanism of data marketplace prices is based on data consumption volume and the rate, which is often static, is decided by the data provider. Even after paying for the data, the data consumer may expend significant effort in data cleansing, for example, to achieve the desired data quality.

Certain embodiments of the concepts, techniques, and structures disclosed herein are directed to data marketplace price correction for data based on the behavior of the data. In some embodiments, static price correction based on quality is applied to a price specified for a data set at time of onboarding of the data set to the data marketplace. In some embodiments, dynamic price correction based on density of errors in the data is applied to a price specified for a data set. Numerous variations and configurations will be apparent in light of this disclosure.

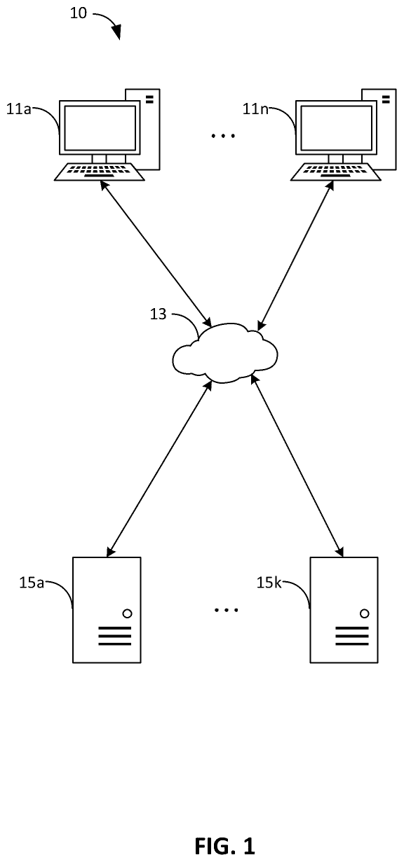

Referring now to FIG. 1, shown is a diagram illustrating an example network environment 10 of computing devices in which various aspects of the disclosure may be implemented, in accordance with an embodiment of the present disclosure. As shown, environment 10 includes one or more client machines 11a-11n (11 generally), one or more server machines 15a-15k (15 generally), and one or more networks 13. Client machines 11 can communicate with server machines 15 via networks 13. Generally, in accordance with client-server principles, a client machine 11 requests, via network 13, that a server machine 15 perform a computation or other function, and server machine 15 responsively fulfills the request, optionally returning a result or status indicator in a response to client machine 11 via network 13.

In some embodiments, client machines 11 can communicate with remote machines 15 via one or more intermediary appliances (not shown). The intermediary appliances may be positioned within network 13 or between networks 13. An intermediary appliance may be referred to as a network interface or gateway. In some implementations, the intermediary appliance may operate as an application delivery controller (ADC) in a datacenter to provide client machines (e.g., client machines 11) with access to business applications and other data deployed in the datacenter. The intermediary appliance may provide client machines with access to applications and other data deployed in a cloud computing environment, or delivered as Software as a Service (SaaS) across a range of client devices, and/or provide other functionality such as load balancing, etc.

Client machines 11 may be generally referred to as computing devices 11, client devices 11, client computers 11, clients 11, client nodes 11, endpoints 11, or endpoint nodes 11. Client machines 11 can include, for example, desktop computing devices, laptop computing devices, tablet computing devices, mobile computing devices, workstations, and/or hand-held computing devices. Server machines 15 may also be generally referred to as a server farm 15. In some embodiments, a client machine 11 may have the capacity to function as both a client seeking access to resources provided by server machine 15 and as a server machine 15 providing access to hosted resources for other client machines 11.

Server machine 15 may be any server type such as, for example, a file server, an application server, a web server, a proxy server, a virtualization server, a deployment server, a Secure Sockets Layer Virtual Private Network (SSL VPN) server; an active directory server; a cloud server; or a server executing an application acceleration program that provides firewall functionality, application functionality, or load balancing functionality. Server machine 15 may execute, operate, or otherwise provide one or more applications. Non-limiting examples of applications that can be provided include software, a program, executable instructions, a virtual machine, a hypervisor, a web browser, a web-based client, a client-server application, a thin-client, a streaming application, a communication application, or any other set of executable instructions.

In some embodiments, server machine 15 may execute a virtual machine providing, to a user of client machine 11, access to a computing environment. In such embodiments, client machine 11 may be a virtual machine. The virtual machine may be managed by, for example, a hypervisor, a virtual machine manager (VMM), or any other hardware virtualization technique implemented within server machine 15.

Networks 13 may be configured in any combination of wired and wireless networks. Network 13 can be one or more of a local-area network (LAN), a wide area network (WAN), a metropolitan area network (MAN), a virtual private network (VPN), a primary public network, a primary private network, the Internet, or any other type of data network. In some embodiments, at least a portion of the functionality associated with network 13 can be provided by a cellular data network and/or mobile communication network to facilitate communication among mobile devices. For short range communications within a wireless local-area network (WLAN), the protocols may include 802.11, Bluetooth, and Near Field Communication (NFC).

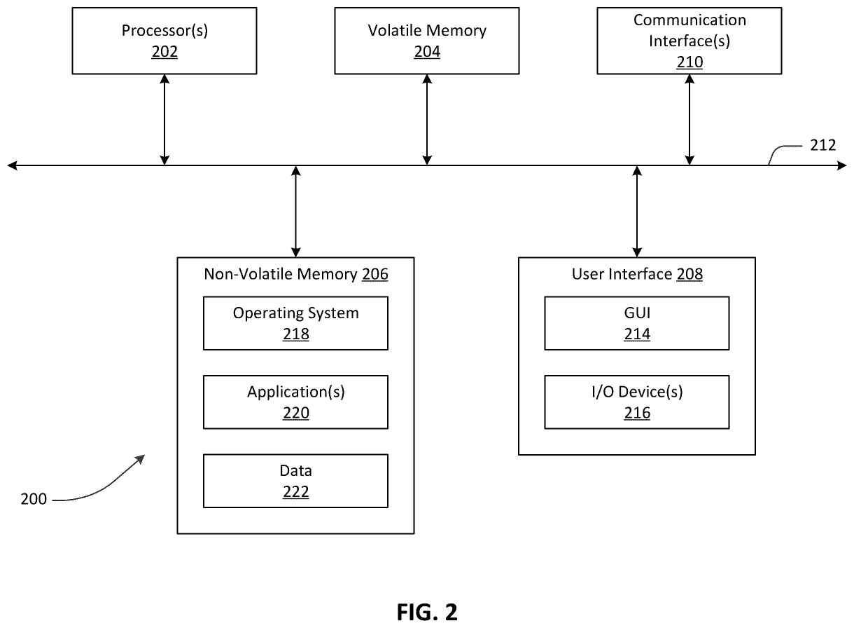

FIG. 2 is a block diagram illustrating selective components of an example computing device 200 in which various aspects of the disclosure may be implemented, in accordance with an embodiment of the present disclosure. For instance, client machines 11 and/or server machines 15 of FIG. 1 can be substantially similar to computing device 200. As shown, computing device 200 includes one or more processors 202, a volatile memory 204 (e.g., random access memory (RAM)), a non-volatile memory 206, a user interface (UI) 208, one or more communications interfaces 210, and a communications bus 212.

Non-volatile memory 206 may include: one or more hard disk drives (HDDs) or other magnetic or optical storage media; one or more solid state drives (SSDs), such as a flash drive or other solid-state storage media; one or more hybrid magnetic and solid-state drives; and/or one or more virtual storage volumes, such as a cloud storage, or a combination of such physical storage volumes and virtual storage volumes or arrays thereof.

User interface 208 may include a graphical user interface (GUI) 214 (e.g., a touchscreen, a display, etc.) and one or more input/output (I/O) devices 216 (e.g., a mouse, a keyboard, a microphone, one or more speakers, one or more cameras, one or more biometric scanners, one or more environmental sensors, and one or more accelerometers, etc.).

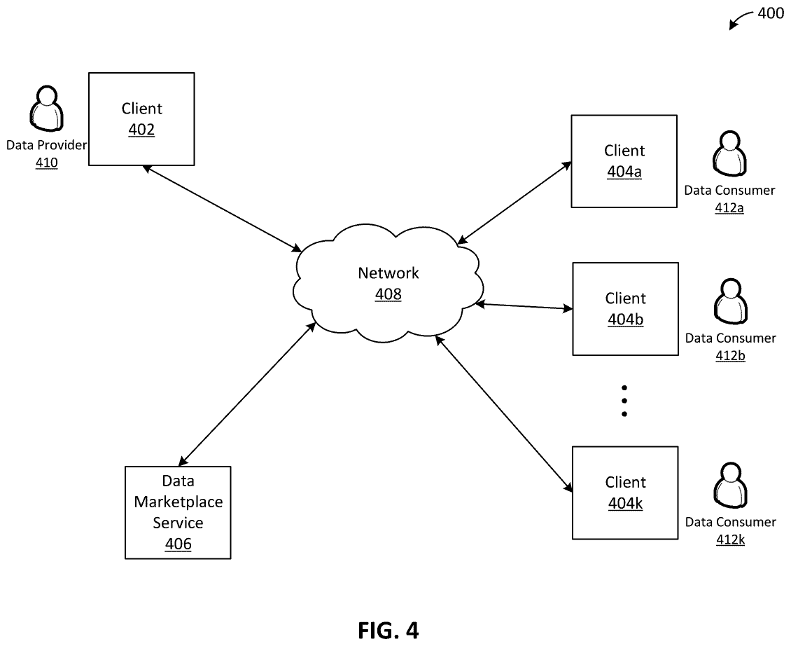

Non-volatile memory 206 stores an operating system 218, one or more applications 220, and data 222 such that, for example, computer instructions of operating system 218 and/or applications 220 are executed by processor(s) 202 out of volatile memory 204. In one example, computer instructions of operating system 218 and/or applications 220 are executed by processor(s) 202 out of volatile memory 204 to perform all or part of the processes described herein (e.g., processes illustrated and described with reference to FIGS. 4 through 7). In some embodiments, volatile memory 204 may include one or more types of RAM and/or a cache memory that may offer a faster response time than a main memory. Data may be entered using an input device of GUI 214 or received from I/O device(s) 216. Various elements of computing device 200 may communicate via communications bus 212.

The illustrated computing device 200 is shown merely as an illustrative client device or server and may be implemented by any computing or processing environment with any type of machine or set of machines that may have suitable hardware and/or software capable of operating as described herein.

Processor(s) 202 may be implemented by one or more programmable processors to execute one or more executable instructions, such as a computer program, to perform the functions of the system. As used herein, the term “processor” describes circuitry that performs a function, an operation, or a sequence of operations. The function, operation, or sequence of operations may be hard coded into the circuitry or soft coded by way of instructions held in a memory device and executed by the circuitry. A processor may perform the function, operation, or sequence of operations using digital values and/or using analog signals.

In some embodiments, the processor can be embodied in one or more application specific integrated circuits (ASICs), microprocessors, digital signal processors (DSPs), graphics processing units (GPUs), microcontrollers, field programmable gate arrays (FPGAs), programmable logic arrays (PLAs), multi-core processors, or general-purpose computers with associated memory.

Processor 202 may be analog, digital, or mixed signal. In some embodiments, processor 202 may be one or more physical processors, or one or more virtual (e.g., remotely located or cloud computing environment) processors. A processor including multiple processor cores and/or multiple processors may provide functionality for parallel, simultaneous execution of instructions or for parallel, simultaneous execution of one instruction on more than one piece of data.

Communications interfaces 210 may include one or more interfaces to enable computing device 200 to access a computer network such as a Local Area Network (LAN), a Wide Area Network (WAN), a Personal Area Network (PAN), or the Internet through a variety of wired and/or wireless connections, including cellular connections.

In described embodiments, computing device 200 may execute an application on behalf of a user of a client device. For example, computing device 200 may execute one or more virtual machines managed by a hypervisor. Each virtual machine may provide an execution session within which applications execute on behalf of a user or a client device, such as a hosted desktop session. Computing device 200 may also execute a terminal services session to provide a hosted desktop environment. Computing device 200 may provide access to a remote computing environment including one or more applications, one or more desktop applications, and one or more desktop sessions in which one or more applications may execute.

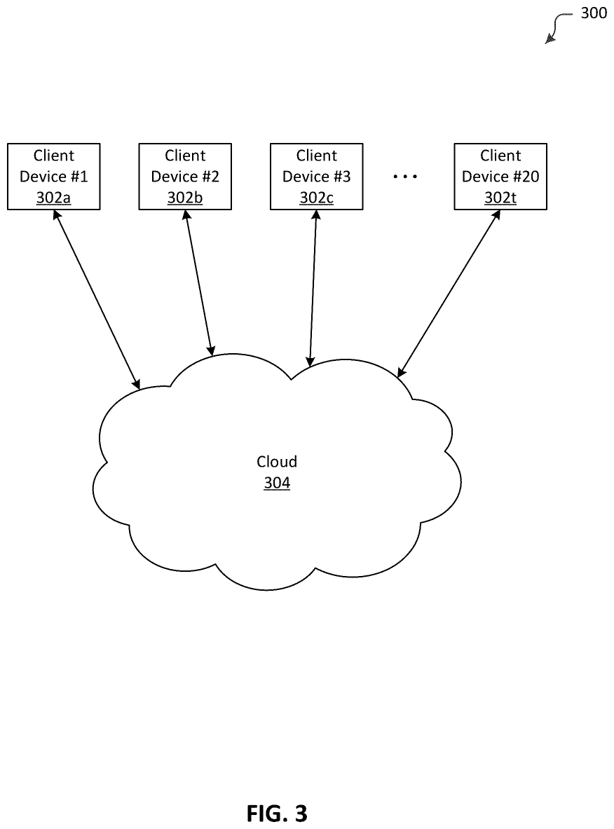

Referring to FIG. 3, shown is a diagram of a cloud computing environment 300 in which various aspects of the concepts described herein may be implemented. Cloud computing environment 300, which may also be referred to as a cloud environment, cloud computing, or cloud network, can provide the delivery of shared computing resources and/or services to one or more users or tenants. For example, the shared resources and services can include, but are not limited to, networks, network bandwidth, servers, processing, memory, storage, applications, virtual machines, databases, software, hardware, analytics, and intelligence.

In cloud computing environment 300, one or more client devices 302a-302t (such as client machines 11 and/or computing device 200 described above) may be in communication with a cloud network 304 (sometimes referred to herein more simply as a cloud 304). Cloud 304 may include back-end platforms such as, for example, servers, storage, server farms, or data centers. The users of clients 302a-302t can correspond to a single organization/tenant or multiple organizations/tenants. More particularly, in one implementation, cloud computing environment 300 may provide a private cloud serving a single organization (e.g., enterprise cloud). In other implementations, cloud computing environment 300 may provide a community or public cloud serving one or more organizations/tenants.

In some embodiments, one or more gateway appliances and/or services may be utilized to provide access to cloud computing resources and virtual sessions. For example, a gateway, implemented in hardware and/or software, may be deployed (e.g., reside) on-premises or on public clouds to provide users with secure access and single sign-on to virtual, SaaS, and web applications. As another example, a secure gateway may be deployed to protect users from web threats.

In some embodiments, cloud computing environment 300 may provide a hybrid cloud that is a combination of a public cloud and a private cloud. Public clouds may include public servers that are maintained by third parties to client devices 302a-302t or the enterprise/tenant. The servers may be located off-site in remote geographical locations or otherwise.

Cloud computing environment 300 can provide resource pooling to serve clients devices 302a-302t (e.g., users of client devices 302a-302n) through a multi-tenant environment or multi-tenant model with different physical and virtual resources dynamically assigned and reassigned responsive to different demands within the respective environment. The multi-tenant environment can include a system or architecture that can provide a single instance of software, an application, or a software application to serve multiple users. In some embodiments, cloud computing environment 300 can include or provide monitoring services to monitor, control, and/or generate reports corresponding to the provided shared resources and/or services.

In some embodiments, cloud computing environment 300 may provide cloud-based delivery of various types of cloud computing services, such as Software as a service (SaaS), Platform as a Service (PaaS), Infrastructure as a Service (IaaS), and/or Desktop as a Service (DaaS), for example. IaaS may refer to a user renting the use of infrastructure resources that are needed during a specified period. IaaS providers may offer storage, networking, servers, or virtualization resources from large pools, allowing the users to quickly scale up by accessing more resources as needed. PaaS providers may offer functionality provided by IaaS, including, e.g., storage, networking, servers, or virtualization, as well as additional resources such as, for example, operating systems, middleware, and/or runtime resources. SaaS providers may offer the resources that PaaS provides, including storage, networking, servers, virtualization, operating systems, middleware, or runtime resources. SaaS providers may also offer additional resources such as, for example, data and application resources. DaaS (also known as hosted desktop services) is a form of virtual desktop service in which virtual desktop sessions are typically delivered as a cloud service along with the applications used on the virtual desktop.

FIG. 4 is a diagram of an illustrative network environment 400 in which data marketplace price correction may be implemented, in accordance with an embodiment of the present disclosure. As shown, illustrative network environment 400 includes a client 402, clients 404a, 404b, . . . , 404k (404 generally), and a data marketplace service 406. Clients 402, 404 may be configured to communicate with data marketplace service 406 via one or more computer networks 408 (e.g., via the Internet). For example, clients 402, 404 may correspond to client machines 11 of FIG. 1. For example, an organization may implement and provide data marketplace service 406 as an online transactional market that facilitates the selling and purchasing of data. In some embodiments, data marketplace service 406 may be provided as part of a cloud computing environment (e.g., cloud computing environment 300 of FIG. 3).

Clients 402, 404 can include, for example, desktop computing devices, laptop computing devices, tablet computing devices, and/or mobile computing devices. Clients 402, 404 can be configured to run one or more applications, such as desktop applications, mobile applications, and SaaS applications. Among various other types of applications, clients 402, 404 can run a client application (e.g., a web browser) that provides access to data marketplace service 406. In some embodiments, a client 402, 404 may be the same or substantially similar to client machine 11 of FIG. 1, computing device 200 of FIG. 2, and/or client device 302 of FIG. 3.

In the example of FIG. 4, a data provider 410 can use client 402 to access and interact with data marketplace service 406. For example, data provider 410 can use client 402 to onboard a data set to data marketplace service 406 for discovery and consumption. As part of the onboarding process, among other information, data provider 410 can specify pricing information (e.g., price per terabyte (TB)) for the onboarded data set.

Upon completion of the onboarding of the data set, in some embodiments, data marketplace service 406 can analyze the data set for quality and apply a static price correction to the price of the data set specified by data provider 410. For example, data marketplace service 406 can determine the quality of a data set based on factors such as number of duplicate rows (or “records”), number of rows with blank data, number of anomalies, and number of dependent fields in the data set. Larger numbers for the first three factors, number of duplicate rows, number of rows with blank data, and number of anomalies, contribute to lowering the quality of the data set. A larger number for the fourth factor, number of dependent fields, contributes to raising the quality of the data set since a data set having a larger number of dependent fields is more detailed and, thus, may be more useful to the consumer. Data marketplace service 406 can derive a static price depreciation coefficient based on the assessed quality of the data set. Data marketplace service 406 can then apply the static price depreciation coefficient to the price specified by data provider 410 to determine a new price of the data set (e.g., compute an adjusted price of the data set). Data marketplace service 406 may send or otherwise provide a notification to data provider 410 informing of the new price of the data set along with information about the quality assessment. In some embodiments, data marketplace service 406 may provide data provider 410 an opportunity to address the quality issues in the data (e.g., correct any deficiencies in the data). For example, in such embodiments, data marketplace service 406 can hold the data set for a predetermined duration, such as, for example, N days (e.g., N=2), before making the data set discoverable by consumers to give data provider 410 an opportunity to correct the quality issues. The value of N may be configured by the organization providing data marketplace service 406 as part of a marketplace policy.

In response to receiving the notification informing of the new price established for the data set, data provider 410 may address some or all the issues identified in the data and onboard a new data set to data marketplace service 406. Data provider 410 may specify pricing information for the new data set, which may be the same price or a different price as the prior data set. Upon completion of the onboarding of the new data set, data marketplace service 406 can analyze the new data set for quality and apply a static price correction to the price specified by data provider 410. In some cases, data provider 410 may not onboard a new data set which addresses some or all the issues identified in the data. In any case, upon passage of the predetermined hold duration, data marketplace service 406 can make the data set provided by data provider 410 (e.g., the data set initially onboarded or the new data set subsequently onboarded) discoverable on data marketplace service 406 for purchase by consumers. Data marketplace service 406 can set the price of the data set to the price specified by data provider 410 with the static price correction applied.

Continuing the example of FIG. 4, data consumers 412a, 412b, . . . , 412k (412 generally) can use their corresponding clients 404a, 404b, . . . , 404k to access and interact with data marketplace service 406. For example, data consumers 412 can use clients 404 to discover and purchase data sets, including the data set provided by data provider 410, on data marketplace service 406. Data consumers 412 may report errors and issues encountered when using data sets purchased on or through data marketplace service 406. Data consumers 412 may also provide feedback (e.g., customer feedback) about data sets purchased on or through data marketplace service 406. To this end, data marketplace service 406 may provide a portal or interface which can be used to report errors and issues and provide feedback regarding data sets purchased on or through data marketplace service 406. For example, data consumers 412 that have purchased the data set provided by data provider 410 may report errors and issues encountered in using the data set as well as feedback about the data set provided by data provider 410.

In some embodiments, data marketplace service 406 can apply a dynamic price correction to the price of the data set specified by data provider 410 based on the density of errors in the data. For example, for a particular data set (e.g., the data set provided by data provider 410), data marketplace service 406 can determine the density of errors in the data by analyzing the errors and issues reported for the data set and the feedbacks about the data set provided by data consumers 412. Non-limiting examples of types of errors and issues that may be captured and analyzed by data marketplace service 406 include errors in using the data (e.g., incorrect email address), errors in processing the data (e.g., error in data conversion), low accuracy of the data (e.g., data generates low or inaccurate results/predictions), delays in data updates by the data provider, and data lineage issues. The feedback about the data set provided by data provider 410 can be analyzed to understand the sentiment, such as, for example, positive and negative, expressed in the feedback toward or directed at the data set by data consumers 412. Data marketplace service 406 can derive a dynamic price depreciation coefficient based on the determined density of errors in the data. Data marketplace service 406 can then apply the dynamic price depreciation coefficient to the price specified by data provider 410 to determine a new price of the data set (e.g., compute an adjusted price of the data set). Data marketplace service 406 may send or otherwise provide a notification to data provider 410 informing of the new price of the data set determined based on the density of errors in the data. The notification may include information about the errors and issues reported by data consumers 412. In response, data provider 410 may address some or all errors and issues with the data and onboard a new data set to data marketplace service 406.

While only one data provider 410 and client 402 are depicted in the example of FIG. 4 for purposes of clarity, it will be appreciated that there may be a larger number of data providers onboarding large number of data sets to data marketplace service 406.

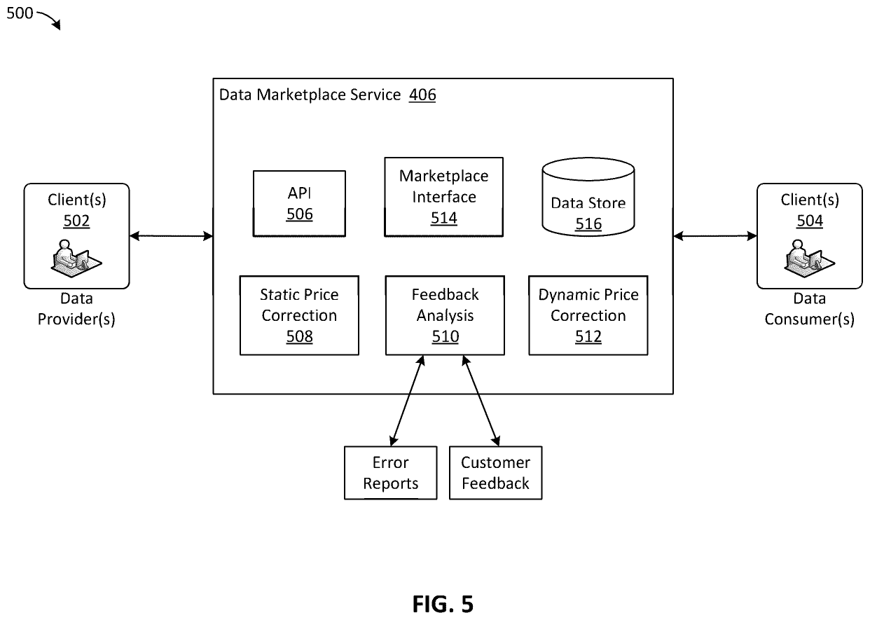

Referring now to FIG. 5 and with continued reference to FIG. 4, shown is a block diagram of an illustrative system 500 for data marketplace price correction, in accordance with an embodiment of the present disclosure. Illustrative system 500 includes one or more clients 502 and one or more clients 504 configured to communicate with data marketplace service 406 via one or more networks (e.g., the Internet). In the example of FIG. 5, clients 502 may correspond to clients 402 used by data providers 410 of FIG. 4 and clients 504 may correspond to clients 404 used by data consumers 412 of FIG. 4.

Clients 502, 504 may include any type of client devices configured to install and/or run applications (or “apps”). For example, a representative client 502 may run a client application, such as a web client or a dedicated application, that a user (e.g., data provider 410 of FIG. 4) can use to access and interact with data marketplace service 406. Similarly, a representative client 504 may run a client application, such as a web client or a dedicated application, that a user (e.g., data consumer 412 of FIG. 4) can use to access and interact with data marketplace service 406. The client application and/or data marketplace service 406 may be implemented as computer instructions executable to perform the corresponding functions disclosed herein. In the example of FIG. 5, data marketplace service 406 includes an application programming interface (API) module 506, a static price correction module 508, a feedback analysis module 510, a dynamic price correction module 512, a marketplace interface 514, and a data store 516.

The client application on client 502, 504 can communicate with data marketplace service 406 using an API. For example, the client application on client 502, 504 can send requests (or “messages”) to data marketplace service 406 wherein the requests are received and processed by API module 506 or one or more other components of data marketplace service 406. Likewise, data marketplace service 406 or one or more components of data marketplace service 406 can utilize API module 506 to send responses/messages to the client application on client 502, 504.

Referring to data marketplace service 406, static price correction module 508 is operable to apply a static price correction to a price of a data set. For example, upon completion of an onboarding of a data set to data marketplace service 406, static price correction module 508 can apply a static price correction to the price of the data set based on the assessed quality of the data in the data set. According to one embodiment, static price correction module 508 can determine the quality of the data based on factors such as number of duplicate rows, number of rows with blank data, number of anomalies, and number of dependent fields in the data set. For example, static price correction module 508 can analyze the data in the data set and determine the rows in the data set that are duplicates of one or more other rows in the data set. Static price correction module 508 can similarly analyze the data in the data set to determine the rows that contain blank data (e.g., the rows that contain no or missing data). Static price correction module 508 can implement or utilize machine learning (ML) models (e.g., linear regression) to detect anomalies in the data (e.g., determine the rows that contain anomalies in the data set).

In some embodiments, for each factor used to determine the quality of the data, static price correction module 508 can define a particular factor depreciation coefficient. For example, static price correction module 508 can define a duplicate data depreciation coefficient of H (e.g., H=0.001) for each 2% duplicate records in the data set, a blank data depreciation coefficient of I (e.g., I=0.002) for each 2% records containing blank data in the data set, and an anomaly depreciation coefficient of J (e.g., J=0.005) for each 2% records containing anomalies in the data set. Static price correction module 508 can define a dependent fields depreciation coefficient of K (e.g., K=−0.003) for each dependent field more than 5 dependent fields in the data set. The values of H, I, J, and K may be configured by the organization as part of a marketplace policy. Thus, the various factor depreciation coefficients can be understood as representing the quality of the data in the data set at the time of onboarding of the data set.

In some embodiments, static price correction module 508 can derive a static price depreciation coefficient based on the assessed quality of the data in the data set, as follows:

$$Static Price Depreciation Coefficient = default\_value \_of \_static \_pricing \_coeff + duplicate data depreciation coefficient + blank data depreciation coefficient + anomaly depreciation coefficient + dependent fields depreciation coefficient ,$$

where default_value_of_static_pricing_coeff is a default value of the static price depreciation coefficient and is set to 1. For example, suppose a data set contains 2% duplicate records and 6 dependent fields. In this example, the static price depreciation coefficient for the data set can be set to 0.998 (1+(0.001+−0.003)=0.998). As another example, suppose a data set contains 4% duplicate records and 2% of the records contain blank data. In this example, the static price depreciation coefficient for the data set can be set to 1.004 (1+(0.001+0.001+0.002)=1.004).

In some embodiments, static price correction module 508 can apply the static price correction to the price of the data set using the static price depreciation coefficient, as follows:

$$New Price = Current Price / Static Price Depreciation Coefficient ,$$

where New Price is the new price (e.g., adjusted price) of the data set resulting from application of the static price correction, Current Price is the price of the data set specified by the data provider, and Static Price Depreciation Coefficient is the static price depreciation coefficient determined based on the quality of the data in the data set. For example, suppose the price of the data set specified by the data provider is $54.00 USD per TB of data, and the static price depreciation coefficient derived for the data set is 1.004. In this example, the new price (e.g., adjusted price) of the data set based on the static price correction is $54.22 USD per TB of data ($54.00/1.004=$54.22). Note that a high static price depreciation coefficient (e.g., static price depreciation coefficient >1) contributes to reduce the price of the data set to a price lower than the price specified by the data provider. Conversely, a low static price depreciation coefficient (e.g., static price depreciation coefficient <1) contributes to increase the price of the data set to a price higher than the price specified by the data provider.

In some embodiments, static price correction module 508 can define a price ceiling and a price floor for a data set. The price ceiling is the maximum price that can be charged for the data set in data marketplace service 406. The price floor is the lowest price that can be charged for the data set in data marketplace service 406. For example, static price correction module 508 can define the price ceiling as C percent (e.g., C=1.50 or 150%) of the price specified by the data provider and the price floor as F percent (e.g., F=0.50 or 50%) of the price specified by the data provider. The values of C and F may be configured by the organization as part of a marketplace policy. The defined price ceiling and price floor provide limits on the price that can be charged for a data set in data marketplace service 406. For example, suppose the price ceiling is defined to be 1.5 and the price floor is defined to be 0.5 of the price specified by the data provider, and the price of a data set specified by the data provider is $50.00 USD per TB of data. In this example, the price per TB of data can reach a price ceiling of $75.00 USD ($50.00*1.5=$75.00) per TB of data and a price floor of $25.00 USD ($50.00*0.5=$25.00) per TB of data. In other words, regardless of the static price depreciation coefficient derived for the data set, the price per TB of data can reach a maximum price of $75.00 USD and a minimum price of $25.00 USD.

In some embodiments, static price correction module 508 can store (e.g., record) the new prices computed for the data sets, including information and data about the new prices and the data sets, within data store 516, where it can subsequently be retrieved and used. In some embodiments, data store 516 may correspond to a storage service within the computing environment of data marketplace service 406.

Feedback analysis module 510 is operable to analyze the error reports and feedback provided by data consumers about the data sets. The error reports and feedback may be provided to data marketplace service 406 by customers (e.g., data consumers) that are using the various data sets purchased on or through data marketplace service 406. In some embodiments, feedback analysis module 510 can analyze the error reports to determine the faulty data reported in the error reports. In particular, for a particular data set, feedback analysis module 510 can determine a count of the faulty data in the data set.

Feedback analysis module 510 can categorize the feedbacks provided by data consumers about the data sets. In some embodiments, for a particular data set, feedback analysis module 510 can utilize Natural Language Processing (NLP) techniques to analyze the contents (e.g., text) of the customer feedbacks about the data set to understand or infer the sentiment, such as worry, happy, satisfied, neutral, sad, or unhappy, among others, expressed in the text toward or directed at the data set by the consumers of the data set. In some cases, this can be accomplished by analyzing the text of the feedbacks to identify the positive or negative intensity of words, phrases, and symbols within the text. Feedback analysis module 510 can determine whether a feedback about the data set is positive or negative based on the sentiments expressed towards the data set in the feedback. For example, if the majority of the sentiment expressed toward a data set in the feedback is happy and satisfied, it can be determined that the feedback about the data set is positive. As another example, if the majority of the sentiment expressed toward the a data set in the feedback is worry, sad, and unhappy, it can be determined that the feedback about the data set is negative.

Feedback analysis module 510 can categorize the errors and issues reported by data consumers about the data set according to the different types of errors and issues. As mentioned previously, examples of types of errors and issues that may be reported by data consumers about a data set include errors in using the data, errors in processing the data, low accuracy of the data, delays in data updates by the data provider, and data lineage issues. The list of the types of errors and issues is merely illustrative, and the types of errors and issues and the numbers of the different types of errors and issues may vary depending on the type of data. In some embodiments, for a particular data set, feedback analysis module 510 can apply a clustering algorithm, such as, for example, a K-means clustering algorithm or a Support Vector Machine (SVM)-based clustering algorithm, to the errors and issues reported about the data set to cluster the reported errors and issues based on the types of errors and issues (e.g., categorize the reported errors and issues into one of the different types of errors and issues).

Feedback analysis module 510 can categorize the negative feedbacks about a data set according to the different types of errors and issues reported by data consumers about the data set. In some embodiments, for a particular data set, feedback analysis module 510 can apply a clustering algorithm, such as, for example, a K-means clustering algorithm or an SVM-based clustering algorithm, to the negative feedbacks about the data set to cluster the negative feedbacks based on the different types of errors and issues reported by the data consumers about the data set. According to one such embodiment, feedback analysis module 510 can utilize a heuristic technique, such as the elbow method, to determine the number of clusters of negative feedback. The number of clusters of negative feedback about a data set can be understood to be the spread of the negative feedbacks across the different types of errors and issues reported about the data set. For example, negative feedbacks distributed across a large number of clusters indicates many errors/issues in the data in the data set. Conversely, negative feedbacks distributed across a small number of clusters indicates a few errors/issues in the data in the data set.

In some embodiments, feedback analysis module 510 can collect (retrieve) and analyze the error reports and feedback provided by data consumers about the data sets on a continuous or periodic basis (e.g., according to a predetermined schedule specified by the organization). In some embodiments, feedback analysis module 510 can store (e.g., record) the results of the analysis (e.g., information and data about counts of faulty data in the data sets, positive and negative feedbacks about the data sets, categorization of the reported errors and issues about the data sets according to the different types of errors and issues, and categorization of the negative feedbacks about the data sets based on the different types of errors and issues) within data store 516, where it can subsequently be retrieved and used.

Dynamic price correction module 512 is operable to apply a dynamic price correction to a price of a data set. The dynamic price correction applied to the price of the data set can be based on the density of errors in the data in the data set. In particular, according to one embodiment, dynamic price correction module 512 can derive a dynamic price depreciation coefficient that is indicative or representative of the density of errors in the data in a data set, as follows:

$$Dynamic Price Depreciation Coefficient = default\_value \_of \_dynamic \_pricing \_coeff + ( x 1 w 1 + x 2 w 2 + x 3 w 3 ) * cluster\_coeff$$

where:
default_value_of_dynamic_pricing_coeff is a default value of the dynamic price depreciation coefficient and is set to 1;

$$x 1 = count of faulty data / total number of rows in the data set ;$$

w1 is a weight assigned to the faulty data (e.g., 1=lowest weight, 5=highest weight);

$$x 2 = ( negative feedback / ( total downloads + download confidence threshold ) ) ;$$

w2 is a weight assigned to negative feedback (e.g., 1=lowest weight, 5=highest weight);

$$x 3 = ( positive feedback / ( total downloads + download confidence threshold ) ) ;$$

w3 is a weight assigned to positive feedback (e.g., 1=lowest weight, 5=highest weight); and

$$cluster\_coeff = ( no . of clusters having negative feedback + 1 ) / \\ ( total no . of clusters of reported errors / issues + no . of clusters having negative feedback ) .$$

As described previously, the count of faulty data, the number of negative feedback, the number of positive feedback, the number of clusters having negative feedback, and the total number of clusters of reported errors/issues may be determined by feedback analysis module 510 and stored within data store 516. The values of w1, w2, and w3 may be configured by the organization as part of a marketplace policy. For example, the weights can be set to favor the data provider (e.g., higher weight assigned to positive feedback), favor the data consumer (e.g., higher weights assigned to the faulty data and negative feedback), or not favor either the data provider or the data consumer. The download confidence threshold is a minimum threshold number of downloads (e.g., TD=100 downloads) that is considered in computing the dynamic price depreciation coefficient. The value of download confidence threshold, TD, may be configured by the organization ad part of a marketplace policy. The cluster_coeff is indicative of the clustering of the negative feedbacks about the data set across the different types of errors and issues reported about the data set.

In some embodiments, dynamic price correction module 512 can apply the dynamic price correction to the price of the data set using the dynamic price depreciation coefficient, as follows:

$$New Price = Current Price / Dynamic Price Depreciation Coefficient ,$$

where New Price is the new price (e.g., adjusted price) of the data set resulting from application of the dynamic price correction, Current Price is the price of the data set specified by the data provider, and Dynamic Price Depreciation Coefficient is the dynamic price depreciation coefficient determined based on the density of errors in the data in the data set.

By way of a simple example, suppose w1, w2, and w3 are set to 1, 5, and 5, respectively, and the download confidence threshold is set to 100 downloads. Also suppose that the price of a data set specified by the data provider is $54.00 USD, the data set contains 10,000,000 rows of data, there are 5,000 downloads of the data set, there are 60,000 faulty data, there are 200 positive feedbacks, there are 200 negative feedbacks, there are 5 clusters of reported errors/issues, and the negative feedbacks are distributed across all 5 clusters of reported errors/issues. In this example, the cluster_coeff is 0.6 ((5+1)/(5+5)=0.6), the Dynamic Price Depreciation Coefficient is 1.0036 (1+((60,000/10,000,000)*1+(200/(5,000+100))*5−(200/(5,000+100))*5)*0.6=1.0036), and the new price of the data set is $53.80 USD ($54.00/1.0036=$53.80).

By way of another example, in the above example, suppose the negative feedbacks are distributed across 2 of the 5 clusters of reported errors/issues. In this example, the cluster_coeff is 0.4 ((2+1)/(5+2)=0.4), the Dynamic Price Depreciation Coefficient is 1.0024 (1+((60,000/10,000,000)*1+(200/(5,000+100))*5−(200/(5,000+100))*5)*0.4=1.0024), and the new price of the data set is $53.87 USD ($54.00/1.0024=$53.87). Note that the negative feedbacks distributed across a larger number of clusters indicates many errors/issues in the data in the data set and, as a result, lowers the price of the data set (e.g., $53.80 vs. $53.87).

In some embodiments, dynamic price correction module 512 can define a price ceiling and a price floor for a data set. The price ceiling is the maximum price that can be charged for the data set in data marketplace service 406. The price floor is the lowest price that can be charged for the data set in data marketplace service 406.

In some embodiments, dynamic price correction module 512 can apply a dynamic price correction to a price of a data set on a continuous or periodic basis (e.g., according to a predetermined schedule specified by the organization). For example, according to one embodiment, dynamic price correction module 512 can apply a dynamic price correction to a price of a data set in conjunction with feedback analysis module 510 analyzing the error reports and feedback provided by data consumers about the data set. In some embodiments, dynamic price correction module 512 can store (e.g., record) the new prices computed for the data sets, including information and data about the new prices and the data sets, within data store 516, where it can subsequently be retrieved and used.

Still referring to data marketplace service 406, marketplace interface 514 is operable to provide an interface with which users and devices may interact with data marketplace service 406. For example, in one embodiment, marketplace interface 514 may provide a communication channel, such as a secure communication channel, for communicating with client devices, such as clients 502, 504. For example, users, such as data provers and data consumers can use their clients to access data marketplace service 406 via the secure communication channel.

In some embodiments, marketplace interface 514 may include user interface (UI) controls/elements which may be presented on a UI of a client application on a client device and utilized to access data marketplace service 406. For example, a user (e.g., data provider) can click/tap/interact with the presented UI controls/elements to authenticate themselves (e.g., provide a username and password) to data marketplace service 406. Once authenticated, the user can click/tap/interact with the presented UI controls/elements to onboard a data set to data marketplace service 406 for discovery and consumption. As another example, an authenticated user can also use the presented controls/elements to receive and/or view notifications informing of new prices of data sets along with information about the assessments that resulted in the new prices. Users (e.g., data consumers) may also use the presented UI controls/elements to discover and/or purchase data sets on data marketplace service 406.

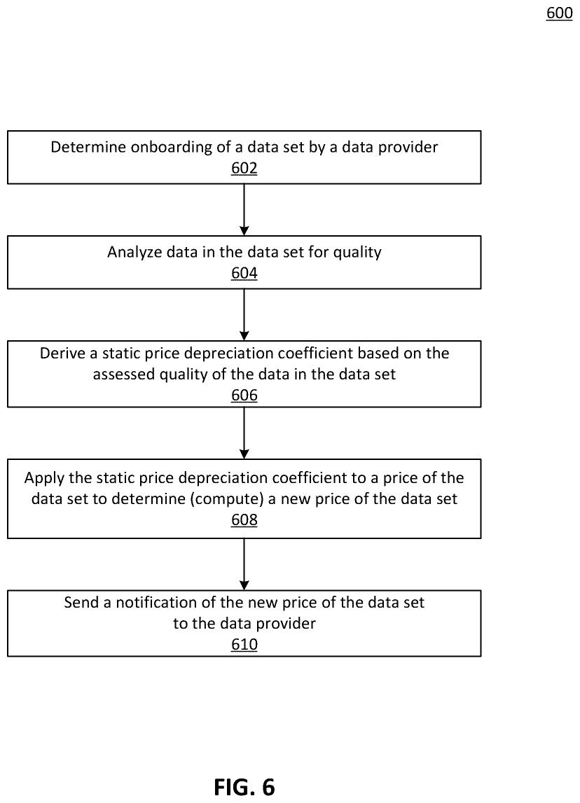

FIG. 6 is a flow diagram of an example process 600 for applying a static price correction to a price of the data set, in accordance with an embodiment of the present disclosure. Illustrative process 600 may be implemented, for example, within data marketplace service 406 of FIGS. 4 and 5. More particularly, some or all of process 600 may be implemented within static price correction module 508 of FIG. 5.

With reference to process 600 of FIG. 6, at 602, onboarding of a data set by a data provider may be determined. For example, a data provider may onboard a data set to data marketplace service 406 for discovery and consumption by data consumers. The data provider may specify a price (e.g., pricing information) of the data set as part of the onboarding process.

At 604, data in the data set may be analyzed for quality. For example, data in the data set may be analyzed for quality based on factors such as number of duplicate rows, number of rows with blank data, number of anomalies, and number of dependent fields in the data set.

At 606, a static price depreciation coefficient based on the assessed quality of the data in the data set may be derived. The static price depreciation coefficient may be based on predetermined depreciation coefficients defined for the factors used in assessing the quality of the data.

At 608, the static price depreciation coefficient may be applied to a price of the data set to determine a new price of the data set. Application of the static price depreciation coefficient can result in a static price correction to the price of the data set based on the assessed quality of the data in the data set. For example, a high static price depreciation coefficient (e.g., static price depreciation coefficient >1) contributes to reduce the price of the data set to a price lower than the price specified by the data provider. Conversely, a low static price depreciation coefficient (e.g., static price depreciation coefficient <1) contributes to increase the price of the data set to a price higher than the price specified by the data provider.

At 610, a notification of the new price of the data set may be sent to the data provider. The notification may include information about the quality assessment which led to the new price of the data set (e.g., information about the quality or quality issues which led to the upward adjustment or the downward adjustment in the price of the data set).

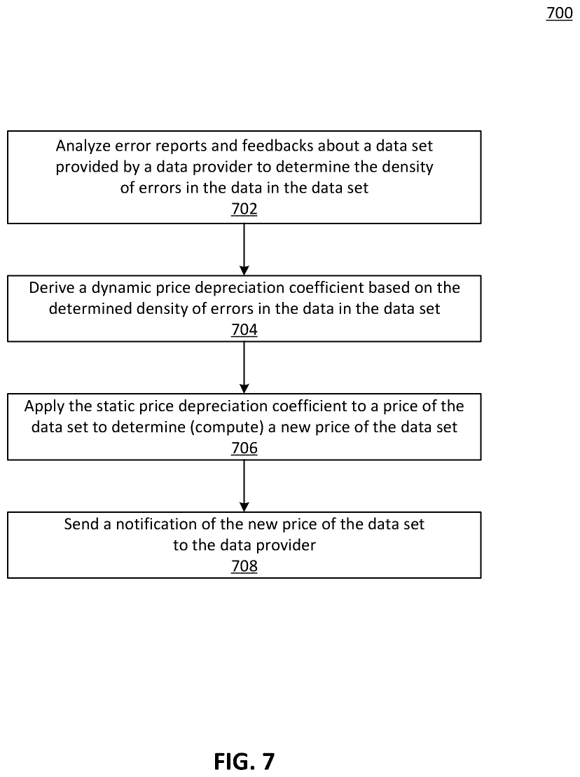

FIG. 7 is a flow diagram of an example process 700 for applying a dynamic price correction to a price of the data set, in accordance with an embodiment of the present disclosure. Illustrative process 700 may be implemented, for example, within data marketplace service 406 of FIGS. 4 and 5. More particularly, some or all of process 700 may be implemented within feedback analysis module 510 and dynamic price correction module 512 of FIG. 5.

With reference to process 700 of FIG. 7, at 702, error reports and feedbacks about a data set may be analyzed to determine the density of errors in the data in the data set. For example, the density of errors in the data may be based on a ratio of a number of faulty data and a number of rows having the faulty data in the data set, a ratio of a number of negative feedbacks about the data set and a number of downloads of the data set, a ratio of a number of positive feedbacks about the data set and a number of downloads of the data set, and/or a cluster coefficient indicative of the clustering of negative feedbacks about the data set across different types of errors and issues reported about the data set.

At 704, a dynamic price depreciation coefficient based on the determined density of errors in the data in the data set may be derived. For example, the dynamic price depreciation coefficient can be understood as providing an indication or representation of the quality of the data in the data set as reported by consumers of the data set. In some embodiments, the density of errors in the data may be based on predetermined weights assigned to the reported faulty data and the different types of feedback (e.g., positive feedback and negative feedback).

At 706, the dynamic price depreciation coefficient may be applied to a price of the data set to determine a new price of the data set. Application of the dynamic price depreciation coefficient can result in a dynamic price correction to the price of the data set based on the density of errors in the data in the data set as reported by consumers of the data set. For example, a high dynamic price depreciation coefficient (e.g., dynamic price depreciation coefficient >1) contributes to reduce the price of the data set to a price lower than the price specified by the data provider. Conversely, a low dynamic price depreciation coefficient (e.g., dynamic price depreciation coefficient <1) contributes to increase the price of the data set to a price higher than the price specified by the data provider.

At 708, a notification of the new price of the data set may be sent to the data provider. The notification may include information about the quality assessment which led to the new price of the data set (e.g., information about the errors and issues and feedbacks which led to the upward adjustment or the downward adjustment in the price of the data set).

In the foregoing detailed description, various features of embodiments are grouped together for the purpose of streamlining the disclosure. This method of disclosure is not to be interpreted as reflecting an intention that the claims require more features than are expressly recited. Rather, inventive aspects may lie in less than all features of each disclosed embodiment.

As will be further appreciated in light of this disclosure, with respect to the processes and methods disclosed herein, the functions performed in the processes and methods may be implemented in differing order. Additionally or alternatively, two or more operations may be performed at the same time or otherwise in an overlapping contemporaneous fashion. Furthermore, the outlined actions and operations are only provided as examples, and some of the actions and operations may be optional, combined into fewer actions and operations, or expanded into additional actions and operations without detracting from the essence of the disclosed embodiments.

Elements of different embodiments described herein may be combined to form other embodiments not specifically set forth above. Other embodiments not specifically described herein are also within the scope of the following claims.

Reference herein to “one embodiment” or “an embodiment” means that a particular feature, structure, or characteristic described in connection with the embodiment can be included in at least one embodiment of the claimed subject matter. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the words “exemplary” and “illustrative” are used herein to mean serving as an example, instance, or illustration. Any aspect or design described herein as “exemplary” or “illustrative” is not necessarily to be construed as preferred or advantageous over other aspects or designs. Rather, use of the words “exemplary” and “illustrative” is intended to present concepts in a concrete fashion.

In the description of the various embodiments, reference is made to the accompanying drawings identified above and which form a part hereof, and in which is shown by way of illustration various embodiments in which aspects of the concepts described herein may be practiced. It is to be understood that other embodiments may be utilized, and structural and functional modifications may be made without departing from the scope of the concepts described herein. It should thus be understood that various aspects of the concepts described herein may be implemented in embodiments other than those specifically described herein. It should also be appreciated that the concepts described herein are capable of being practiced or being carried out in ways which are different than those specifically described herein.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although illustrative embodiments of the present disclosure have been described in detail, various changes, substitutions, and alterations could be made hereto without departing from the scope of the present disclosure. Accordingly, it is intended that the scope of the present disclosure be limited not by this detailed description, but rather by the claims appended hereto.

What is claimed is:

1. A method comprising:
determining, by a computing device, an onboarding of a data set to a data marketplace service by a data provider;
analyzing, by the computing device, data in the data set for quality;
deriving, by the computing device, a static price depreciation coefficient based on the quality of the data in the data set;
applying, by the computing device, the static price depreciation coefficient to a price of the data set to determine a first new price of the data set, wherein the price of the data set is specified by the data provider; and
sending, by the computing device, a first notification of the first new price of the data set to the data provider.

2. The method of claim 1, wherein the quality of the data is based on a number of duplicate rows in the data set.

3. The method of claim 1, wherein the quality of the data is based on a number of rows with blank data in the data set.

4. The method of claim 1, wherein the quality of the data is based on a number of anomalies in the data set.

5. The method of claim 1, wherein the quality of the data is based on a number of dependent fields in the data set.

6. The method of claim 1, further comprising, by the computing device:
analyzing error reports and feedbacks about the data set to determine a density of errors in the data in the data set;
deriving a dynamic price depreciation coefficient based on the density of errors in the data in the data set;
applying the dynamic price depreciation coefficient to the price of the data set to determine a second new price of the data set; and
sending a second notification of the second new price of the data set to the data provider.

7. The method of claim 6, wherein the density of errors is based on a ratio of a number of faulty data and a number of rows having the faulty data in the data set.

8. The method of claim 6, wherein the density of errors is based on a ratio of a number of negative feedbacks about the data set and a number of downloads of the data set.

9. The method of claim 6, wherein the density of errors is based on a ratio of a number of positive feedbacks about the data set and a number of downloads of the data set.

10. The method of claim 6, wherein the density of errors is based on a cluster coefficient indicative of the clustering of negative feedbacks about the data set across different types of errors and issues reported about the data set.

11. A computing device comprising:
one or more non-transitory machine-readable mediums configured to store instructions; and
one or more processors configured to execute the instructions stored on the one or more non-transitory machine-readable mediums, wherein execution of the instructions causes the one or more processors to carry out a process comprising:
determining an onboarding of a data set to a data marketplace service by a data provider;
analyzing data in the data set for quality;
deriving a static price depreciation coefficient based on the quality of the data in the data set;
applying the static price depreciation coefficient to a price of the data set to determine a first new price of the data set, wherein the price of the data set is specified by the data provider; and
sending a first notification of the first new price of the data set to the data provider.

12. The computing device of claim 11, wherein the quality of the data is based on one of a number of duplicate rows in the data set, a number of rows with blank data in the data set, a number of anomalies in the data set, or a number of dependent fields in the data set.

13. The computing device of claim 11, wherein the process further comprises:
analyzing error reports and feedbacks about the data set to determine a density of errors in the data in the data set;
deriving a dynamic price depreciation coefficient based on the density of errors in the data in the data set;
applying the dynamic price depreciation coefficient to the price of the data set to determine a second new price of the data set; and
sending a second notification of the second new price of the data set to the data provider.

14. The computing device of claim 13, wherein the density of errors is based on a ratio of a number of faulty data and a number of rows having the faulty data in the data set.

15. The computing device of claim 13, wherein the density of errors is based on a ratio of a number of negative feedbacks about the data set and a number of downloads of the data set.

16. The computing device of claim 13, wherein the density of errors is based on a ratio of a number of positive feedbacks about the data set and a number of downloads of the data set.

17. The computing device of claim 13, wherein the density of errors is based on a cluster coefficient indicative of the clustering of negative feedbacks about the data set across different types of errors and issues reported about the data set.

18. A method comprising:
analyzing, by a computing device, error reports and feedbacks about a data set to determine a density of errors in data in the data set, wherein the error reports and the feedbacks provided by data consumers using the data in the data set;
deriving, by the computing device, a dynamic price depreciation coefficient based on the density of errors in the data in the data set;
applying, by the computing device, the dynamic price depreciation coefficient to a price of the data set to determine a new price of the data set, wherein the price of the data set is specified by a data provider that provided the data set; and
sending, by the computing device, a notification of the new price of the data set to the data provider.

19. The method of claim 18, wherein the density of errors is based on one of a ratio of a number of faulty data and a number of rows having the faulty data in the data set, a ratio of a number of negative feedbacks about the data set and a number of downloads of the data set, or a ratio of a number of positive feedbacks about the data set and a number of downloads of the data set.

20. The method of claim 18, wherein the density of errors is based on a cluster coefficient indicative of the clustering of negative feedbacks about the data set across different types of errors and issues reported about the data set
